(19) United States
(12) Patent Application Publication
(10) Pub. No.: US 2026/0147298 A1
(43) Pub. Date: May 28, 2026

(54) FIXING DEVICE AND IMAGE FORMING APPARATUS

(71) Applicant: FUJIFILM Business Innovation Corp., Tokyo (JP)

(72) Inventors: Taisei SEO, Kanagawa (JP); Motoyuki YAGI, Kanagawa (JP); Yasushi FUJIWARA, Kanagawa (JP); Noriaki KISHI, Kanagawa (JP)

(73) Assignee: FUJIFILM Business Innovation Corp., Tokyo (JP)

(21) Appl. No.: 19/184,399

(22) Filed: Apr. 21, 2025

(30) Foreign Application Priority Data
Nov. 22, 2024 (JP) 2024-204232

(51) Int. Cl. G03G 15/20

(52) U.S. Cl. CPC G03G 15/206; G03G 15/2064

(57) ABSTRACT

A fixing device includes a rotational body heated by a heat source, an endless belt that rotates while being pressed against the rotational body with a pressure contact portion, and a holding portion that is disposed inside the belt at a portion upstream from the pressure contact portion in a movement direction of the belt, and that holds two end portions of the belt in a width direction crossing the movement direction of the belt, at portions upstream from a center portion of the belt.

### CROSS-REFERENCE TO RELATED APPLICATIONS

This application is based on and claims priority under 35 USC 119 from Japanese Patent Application No. 2024-204232 filed Nov. 22, 2024.

### BACKGROUND

### (i) Technical Field

The present disclosure relates to a fixing device and an image forming apparatus.

### (ii) Related Art

Japanese Unexamined Patent Application Publication No. 2006-151687 and Japanese Unexamined Patent Application Publication No. 2008-184245 disclose examples of a known technology relating to a fixing device.

Japanese Unexamined Patent Application Publication No. 2006-151687 describes a pressing member including an endless belt with a thickness that varies in a rotation axis direction, the endless belt having a first area with a thickness further decreasing from a center portion to an end portion, and a second area that is disposed out of the first area in the rotation axis direction and that is a predetermined thickness thicker than an extended portion of the curve of the first area.

Japanese Unexamined Patent Application Publication No. 2008-184245 describes a holding member including an upstream portion adjuster that is disposed upstream in the rotation direction of an endless belt member and in which a center portion in the longitudinal direction protrudes more highly than the other portion to have a curved surface that lowers from the center portion toward both end portions.

### SUMMARY

Aspects of non-limiting embodiments of the present disclosure relate to a fixing device that presses an endless belt against a rotational body with a pressure contact portion disposed inside the belt. The fixing device includes a holding portion that holds the belt at a portion upstream from the pressure contact portion in a movement direction of the belt. The fixing device reduces creases produced in a recording medium than a structure including a holding portion that linearly holds the belt in a width direction crossing the movement direction of the belt.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a fixing device that includes

a rotational body heated by a heat source;

an endless belt that rotates while being pressed against the rotational body with a pressure contact portion; and

a holding portion that is disposed inside the belt at a portion upstream from the pressure contact portion in a movement direction of the belt, and that holds two end portions of the belt in a width direction crossing the movement direction of the belt, at portions upstream from a center portion of the belt.

### BRIEF DESCRIPTION OF THE DRAWINGS

Exemplary embodiments of the present disclosure will be described in detail based on the following figures, wherein:

FIG. 1 is an entire structure diagram of an image forming apparatus including a fixing device according to a first exemplary embodiment of the present disclosure;

FIG. 2 is a cross-sectional structure view of the fixing device according to the first exemplary embodiment of the present disclosure;

FIG. 3 is a perspective structure view of a related portion of the fixing device according to the first exemplary embodiment of the present disclosure;

FIG. 4 is a cross-sectional structure view of a related portion of the fixing device according to the first exemplary embodiment of the present disclosure;

FIG. 5 is a perspective structure view of a pressing holding member;

FIG. 6 is a perspective structure view of first and second support members;

FIGS. 7A and 7B are diagrams illustrating the operation of an existing fixing device;

FIG. 8 is a plan structure view of a pressing holding member of the fixing device according to the first exemplary embodiment of the present disclosure;

FIG. 9 is a structure diagram illustrating effects of the fixing device according to the first exemplary embodiment of the present disclosure; and

FIG. 10 is a table of an experiment example.

### DETAILED DESCRIPTION

Forms that embody the present disclosure (hereafter referred to as "exemplary embodiments") are described below with reference to the drawings.

### First Exemplary Embodiment

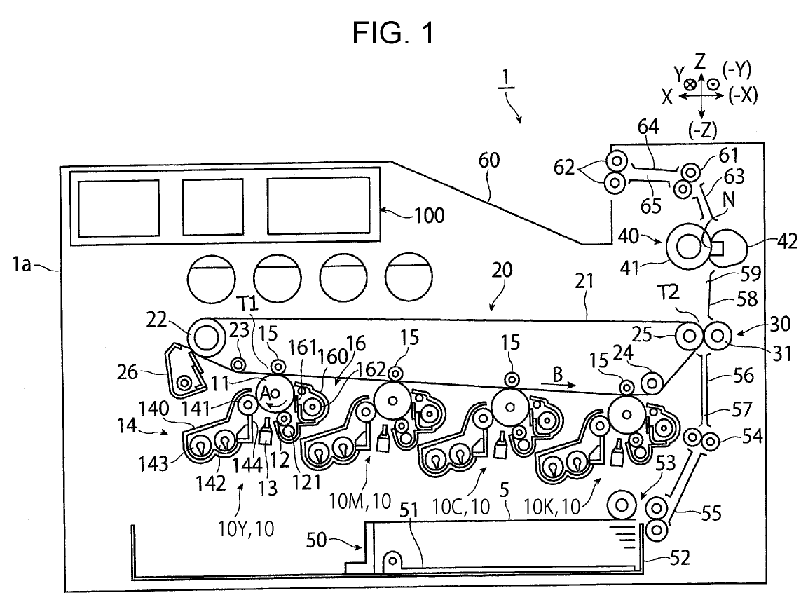

FIG. 1 is a schematic diagram of the entirety of an image forming apparatus including a fixing device according to a first exemplary embodiment. In the drawings, arrow X denotes the width direction parallel to the horizontal direction, arrow Y denotes the depth direction parallel to the horizontal direction, and arrow Z denotes the vertical direction.

### Structure of Entirety of Image Forming Apparatus

An image forming apparatus 1 is, for example, a color printer. As illustrated in FIG. 1, the image forming apparatus 1 includes, for example, multiple image forming devices 10, an intermediate transfer device 20, a sheet feeding device 50, and a fixing device 40. The image forming devices 10 form toner images developed with toner constituting a developer. The intermediate transfer device 20 holds toner images respectively formed by the image forming devices 10, and transports the toner images to a second transfer position T2 at which the toner images are finally second-transferred to a recording sheet 5 serving as an example of a recording medium. The sheet feeding device 50 accommodates and transports an intended recording sheet 5 to be fed to the second transfer position T2 of the intermediate transfer device 20. The fixing device 40 fixes a toner image on the recording sheet 5 second-transferred by the intermediate transfer device 20. Here, the multiple image forming devices 10 and the intermediate transfer device 20 form an image forming unit that forms an image on the recording sheet 5. The fixing device 40 is an example of a fixing unit. An apparatus body 1a includes components such as a support structure member and an outer cover.

The image forming devices 10 include four image forming devices 10Y, 10M, 10C, and 10K that are respectively dedicated to form toner images of four colors including yellow (Y), magenta (M), cyan (C), and black (K). These image forming devices 10 (10Y, 10M, 10C, and 10K) are arranged in an internal space of the apparatus body 1a in a line while being inclined with respect to the horizontal direction X.

As illustrated in FIG. 1, each of the image forming devices 10 (10Y, 10M, 10C, and 10K) includes a photoconductor drum 11 serving as an example of an image carrier that rotates. Around the photoconductor drum 11, components such as a charging device 12, an exposure device 13, a developing device 14, a first transfer device 15, and a drum cleaning device 16 are arranged. The charging device 12 electrically charges, with a predetermined potential, the circumferential surface (the image holding surface) of the photoconductor drum 11 on which an image is formed. The exposure device 13 forms an electrostatic latent image (for the corresponding color) having a potential difference by irradiating the electrically charged circumferential surface of the photoconductor drum 11 with light based on information (a signal) of the image. The developing device 14 develops the electrostatic latent image with toner included in the developer of the corresponding color (Y, M, C, or K) into a toner image. The first transfer device 15 transfers each toner image to the intermediate transfer device 20. The drum cleaning device 16 cleans the photoconductor drum 11 after first transfer by removing extraneous matter such as toner left on and adhering to an image holding surface of the photoconductor drum 11.

The photoconductor drum 11 has the image holding surface having a photoconductive layer (photosensitive layer) formed from a photosensitive material at the circumferential surface of a hollow or solid cylindrical base member that is grounded. The photoconductor drum 11 is supported to rotate in a direction of arrow A with a driving force transmitted from a driving device not illustrated.

The charging device 12 is formed from a contact charging roller disposed to be in contact with the photoconductor drum 11. The charging device (charging roller) 12 receives a charging voltage. When the developing device 14 performs reversal development, the charging roller 12 receives, as a charging voltage, a voltage or a current of the same polarity as the polarity with which toner fed from the developing device 14 is charged. A cleaning roller 121 that cleans the surface of the charging device 12 is disposed at the rear surface of the charging device 12 while being in contact with the rear surface of the charging device 12.

The exposure device 13 includes, for example, a light emitting diode (LED) print head that forms electrostatic latent images by irradiating the photoconductor drum 11 with light corresponding to image information using light emitting diodes (LEDs) serving as multiple light emitting devices arranged in the axial direction of the photoconductor drum 11. At the time when the exposure device 13 is to form a latent image, image information (signals) input into the image forming apparatus 1 with an appropriate device is transmitted to the exposure device 13.

As illustrated in FIG. 1, each of the developing devices 14 includes a housing 140, a development roller 141, agitation transport members 142 and 143, and a layer thickness restricting member 144. The housing 140 includes an opening portion and a developer accommodating chamber. The development roller 141 holds the developer and transports the developer to a development area facing the photoconductor drum 11. The agitation transport members 142 and 143 each include a component such as a screw auger that transports the developer to allow the developer to pass the development roller 141 while agitating the developer. The layer thickness restricting member 144 restricts the amount (layer thickness) of the developer held by the development roller 141. A development voltage is applied across the development roller 141 and the photoconductor drum 11 from a power supply device not illustrated to the developing device 14. The development roller 141 and the agitation transport members 142 and 143 each rotate in a predetermined direction with a driving force transmitted from a driving device not illustrated. A binary developer containing nonmagnetic toner and a magnetic carrier is used as the developer of each of the four colors (Y, M, C, or K).

The first transfer device 15 is a contact transfer device including a first transfer roller to which a first transfer voltage is fed. The first transfer device 15 rotates while coming into contact with the circumferential surface of the photoconductor drum 11 at a first transfer position T1 with an intermediate transfer belt 21 interposed therebetween. A voltage of a direct current with a polarity opposite to the polarity with which toner is charged is applied as a first transfer voltage from a power supply device not illustrated.

The drum cleaning device 16 includes, for example, a container body 160, a cleaning blade 161, and a dispatching member 162. The cleaning blade 161 is disposed at the opening portion of the container body 160 to clean the photoconductor drum 11 by removing extraneous matter such as remaining toner. The dispatching member 162 includes, for example, a screw auger that recovers extraneous matter such as toner removed by the cleaning blade 161, and transports the extraneous matter to a recovery system not illustrated.

The intermediate transfer device 20 is located above the image forming devices 10 (10Y, 10M, 10C, and 10K) in the vertical direction Z. The intermediate transfer device 20 roughly includes the intermediate transfer belt 21, multiple belt support rollers 22-25, a second transfer device 30, and a belt cleaning device 26. The intermediate transfer belt 21 circularly moves in a direction indicated by arrow B while passing the first transfer positions T1 between the photoconductor drum 11 and the first transfer devices 15. The multiple belt support rollers 22-25 hold the intermediate transfer belt 21 from the inner periphery in an intended state to allow the intermediate transfer belt 21 to move circularly. The second transfer device 30 is disposed to face the outer peripheral surface (image holding surface) of the intermediate transfer belt 21 supported by the belt support roller 25, to second-transfer a toner image on the intermediate transfer belt 21 to the recording sheet 5. The belt cleaning device 26 removes extraneous matter such as toner or paper dust left on and adhering to the outer peripheral surface of the intermediate transfer belt 21 that has passed the second transfer device 30 to clean the intermediate transfer belt 21.

The intermediate transfer belt 21 is an endless belt formed from a material obtained by dispersing a resistance regulator such as carbon black into a synthetic resin such as a polyimide resin or a polyamide resin. The belt support roller 22 serves as a driving roller. The belt support roller 23 serves as a holding roller that holds the intermediate transfer belt 21 in a travelling position. The belt support roller 24 serves as a sensor roller with which a sensor not illustrated faces. The belt support roller 25 serves as a backup roller for second transfer.

The second transfer device 30 includes a second transfer roller 31 that rotates at a second transfer position T2, which is an outer peripheral surface portion of the intermediate transfer belt 21 supported by the belt support roller 25 of the intermediate transfer device 20. The second transfer roller 31 or the belt support roller 25 of the intermediate transfer device 20 receives a voltage of a direct current with a polarity the same as or opposite to the polarity with which toner is charged as a second transfer voltage.

The fixing device 40 includes components such as a heating roller 41 and a pressing belt 42. The heating roller 41 is heated by a heat source to keep the surface temperature at a predetermined temperature. The pressing belt 42 rotates while being in contact with the heating roller 41 at a predetermined pressure. In the fixing device 40, a contact portion where the heating roller 41 and the pressing belt 42 are in contact serves as a fixing process portion N that performs a predetermined fixing process (heating and pressing). The fixing device 40 is described later in detail.

The sheet feeding device 50 is disposed below the image forming devices 10 (10Y, 10M, 10C, and 10K) in the vertical direction Z. The sheet feeding device 50 roughly includes a sheet container 52 and a pick-up device 53. The sheet container 52 accommodates, on a receiving plate 51, a stack of recording sheets 5 of, for example, an intended size or an intended type. The pick-up device 53 picks up the recording sheets 5 one by one from the sheet container 52. The sheet container 52 is attached to be drawn out to, for example, the front of the apparatus body 1a (the side that a user faces when operating the image forming apparatus 1).

Examples of the recording sheets 5 include thin paper sheets including ordinary sheets or tracing paper sheets used for, for example, an electrophotographic copying machine or a printer, and overhead projector (OHP) sheets formed from transparent film media made of a synthetic resin (such as polyethylene terephthalate (PET)). To further improve the smoothness of the image surface that has undergone fixing, the recording sheet 5 preferably has a surface as smooth as possible. For example, a coated paper sheet obtained by coating a surface of an ordinary sheet with resin or another material, or a cardboard sheet with a relatively large basis weight such as an art paper sheet for printing is preferably usable as the recording sheet 5.

A fed-sheet transport path 57 is disposed between the sheet feeding device 50 and the second transfer device 30. The fed-sheet transport path 57 includes one pair (or more pairs) of sheet transport rollers 54 that transport the recording sheets 5 fed from the sheet feeding device 50 to the second transfer position T2, and transport guide members 55 and 56. The pair of sheet transport rollers 54 disposed at a position immediately in front of the second transfer position T2 on the fed-sheet transport path 57 serve as, for example, registration rollers that adjust the timing to transport the recording sheets 5.

A sheet transport path 59 is disposed between the second transfer device 30 and the fixing device 40. The sheet transport path 59 includes, for example, a transport guide member 58 that transports the recording sheets 5 fed from the second transfer device 30 to the fixing device 40.

A discharging transport path 65 is disposed downstream from the fixing device 40. The discharging transport path 65 includes, for example, a pair of sheet transport rollers 61, a pair of sheet discharging rollers 62, and transport guide members 63 and 64 that discharge the recording sheet 5 to which a toner image is fixed by the fixing device 40 to a sheet discharge portion 60 disposed at an upper portion of the apparatus body 1a.

FIG. 1 also illustrates a control device 100 serving as an example of a control unit that generally controls the operations of the image forming apparatus 1.

### Basic Operation of Image Forming Apparatus

A basic image forming operation performed by the image forming apparatus 1 is described below.

An image forming operation performed to form a full-color image with a combination of four-color (Y, M, C, and K) toner images using the four image forming devices 10 (10Y, 10M, 10C, and 10K) is described below. An image forming operation performed to form an image with a single color such as a monochrome image or a combination of multi-color toner images using one or more of the four image forming devices 10 (10Y, 10M, 10C, and 10K) is basically performed in the same manner.

When the image forming apparatus 1 receives request command information for an image forming operation (print), the control device 100 controls components including the image forming devices 10 (10Y, 10M, 10C, and 10K), the intermediate transfer device 20, the second transfer device 30, and the fixing device 40 to actuate the components.

In each of the image forming devices 10 (10Y, 10M, 10C, and 10K), first, the photoconductor drum 11 rotates in a direction of arrow A. The charging device 12 electrically charges the surface of the photoconductor drum 11 with a predetermined polarity (a negative polarity in the first exemplary embodiment) and a predetermined potential. Subsequently, the exposure device 13 exposes the electrically charged surface of the photoconductor drum 11 with light emitted based on an image signal obtained by converting, into a corresponding color component (Y, M, C, or K), image information input into the image forming apparatus 1. Thus, an electrostatic latent image of the color component formed by a predetermined potential difference is formed on the surface of the photoconductor drum 11.

Subsequently, each of the developing devices 14 develops the electrostatic latent image of the color component formed on the photoconductor drum 11 by electrostatically adhering toner of the corresponding color (Y, M, C, or K) electrically charged with the intended polarity (negative polarity) to the electrostatic latent image. With this development, the electrostatic latent image of the color component formed on the photoconductor drum 11 is developed with toner of the corresponding color and formed into a toner image of the corresponding one of four colors (Y, M, C, and K) as a visible image.

Subsequently, the toner image of the corresponding color formed on the photoconductor drum 11 of each of the image forming devices 10 (10Y, 10M, 10C, and 10K) is transported to the first transfer position T1. The first transfer device 15 then first-transfers the toner image of the corresponding color to sequentially overlap the toner image onto the intermediate transfer belt 21 of the intermediate transfer device 20 that rotates in the direction of arrow B.

In each of the image forming devices 10 (10Y, 10M, 10C, and 10K) that has finished first transfer, the drum cleaning device 16 scratches off extraneous matter to clean the surface of the photoconductor drum 11. Thus, each of the image forming devices 10 (10Y, 10M, 10C, and 10K) is prepared for the next image forming operation.

Subsequently, the intermediate transfer device 20 holds the first-transferred toner image and transports the toner image to the second transfer position T2 with rotation of the intermediate transfer belt 21. The sheet feeding device 50 feeds an intended recording sheet 5 to the fed-sheet transport path 57 in accordance with the image forming operation. On the fed-sheet transport path 57, the pair of sheet transport rollers 54 serving as registration rollers feed the recording sheet 5 to the second transfer position T2 in accordance with transfer timing.

At the second transfer position T2, the second transfer roller 31 collectively second-transfers the toner images on the intermediate transfer belt 21 to the recording sheet 5. In the intermediate transfer device 20 that has finished second transfer, the belt cleaning device 26 removes extraneous matter such as toner left on the surface of the intermediate transfer belt 21 after second transfer to clean the intermediate transfer belt 21.

Subsequently, after being released from the intermediate transfer belt 21 and the second transfer roller 31, the recording sheet 5 to which the toner image is second-transferred is transported to the fixing device 40 along the sheet transport path 59. The fixing device 40 introduces the second-transferred recording sheet 5 into the fixing process portion N between the rotating heating roller 41 and the rotating pressing belt 42 to allow the recording sheet 5 to pass through the fixing process portion N. The fixing device 40 thus performs an intended fixing process (heating and pressing) to fix an unfixed toner image to the recording sheet 5. The recording sheet 5 that has undergone the fixing process is discharged by the pair of sheet discharging rollers 62 through the discharging transport path 65 to the sheet discharge portion 60 disposed at an upper portion of the apparatus body 1a.

With the above operation, a full-color image formed with a combination of toner images of toner of the four colors (Y, M, C, and K) is output.

### Structure of Fixing Device

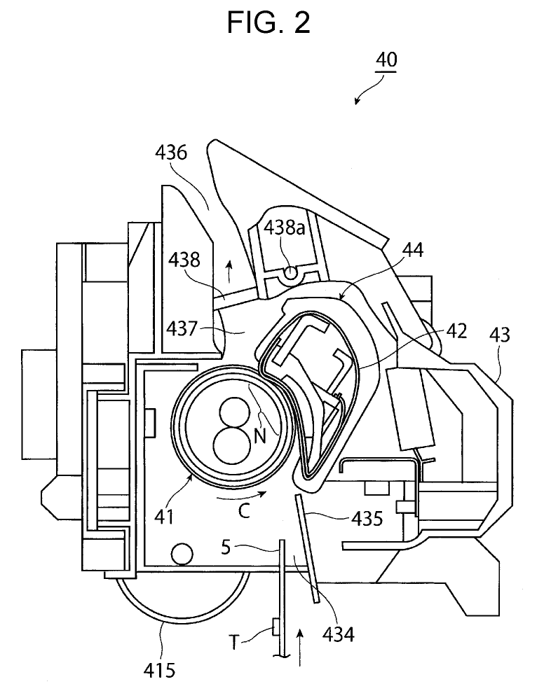

FIG. 2 is a cross-sectional view of the entirety of the fixing device according to the first exemplary embodiment. The fixing device 40 according to the first exemplary embodiment is a so-called free belt nip fuser (FBNF) fixing device.

As illustrated in FIG. 2, the fixing device 40 includes a device housing 43 serving as an example of a housing. Inside the device housing 43, the heating roller 41 serving as an example of a rotational body and the pressing belt 42 serving as an example of an endless belt are disposed while being in pressure contact with each other at the fixing process portion N serving as a pressure contact portion.

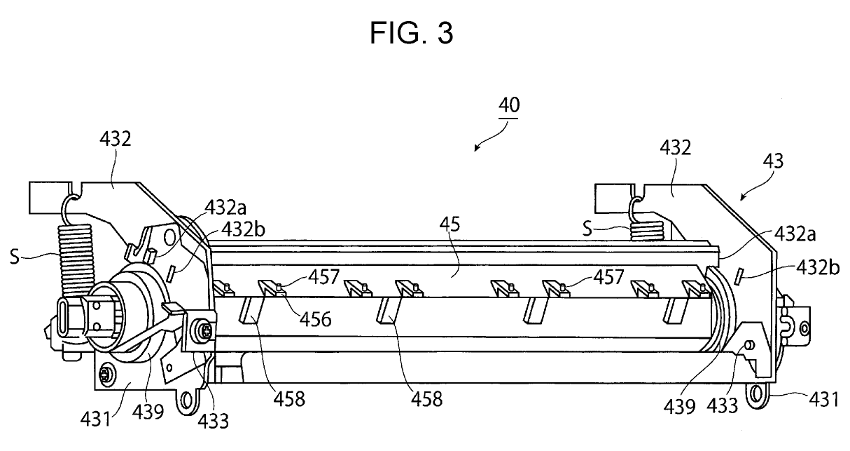

As illustrated in FIG. 3, the device housing 43 includes first support frames 431, second support frames 432, and an outer cover, not illustrated, covering the outer peripheries of the first and second support frames 431 and 432. The first support frames 431 support both end portions of the heating roller 41 in the axial direction while allowing the heating roller 41 to rotate. The second support frames 432 support both end portions of the pressing belt 42 in the longitudinal direction (width direction) while allowing the pressing belt 42 to rotate. Each second support frame 432 is attached to the corresponding first support frame 431 to be rotatable about a rotation shaft 433 with respect to the first support frame 431. A coil spring S in FIG. 3 is disposed between each second support frame 432 and the corresponding first support frame 431. The coil spring S serves as an example of an urging member that presses the pressing belt 42 held by each second support frame 432 against the heating roller 41.

As illustrated in FIG. 2, the device housing 43 includes, in its lower end surface, an inlet port 434 that introduces the recording sheet 5 to which an unfixed toner image T is transferred to the inside. Inside the inlet port 434, a guide plate 435 is disposed while being inclined obliquely upward. The guide plate 435 guides the recording sheet 5 to the fixing process portion N where the heating roller 41 and the pressing belt 42 are in pressure contact with each other. The device housing 43 also includes a discharge port 436 at a left end portion in its upper end surface. The discharge port 436 discharges, to the outside, the recording sheet 5 that has undergone the fixing process with the heating roller 41 and the pressing belt 42. At the discharge port 436, an outlet roller not illustrated is rotatably disposed as appropriate to transport the recording sheet 5 out of the device housing 43. The recording sheet 5 is transported while having the center in the depth direction Y crossing the transport direction as a reference (so-called center registration).

At a transport path 437 disposed between the fixing process portion N of the fixing device 40 and the discharge port 436, an actuator 438 with a stick shape is disposed to be rotatable in a clockwise direction about a shaft 438a. The actuator 438 is an example of a detector that is rotated by the recording sheet 5 passing the transport path 437, and that detects passage of the recording sheet 5. The rotational operation of the actuator 438 is detected as passage of the recording sheet 5 by, for example, an optical sensor not illustrated.

As illustrated in FIG. 2, the fixing device 40 roughly includes the heating roller 41 and a pressing unit 44 that holds the pressing belt 42 pressed against the heating roller 41.

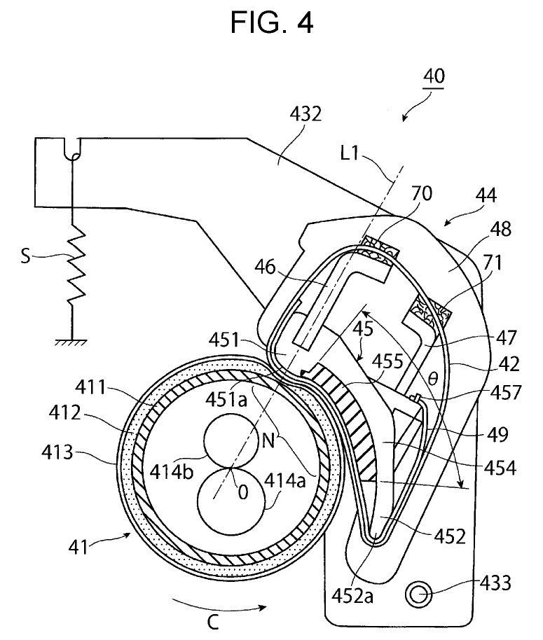

As illustrated in FIG. 4, the heating roller 41 includes a hollow cylindrical core 411, an elastic layer 412, and a release layer 413. The core 411 is formed from a metal such as stainless steel, aluminum, or iron (a thin-walled high strength steel pipe). The core 411 has a cylinder shape with a relatively small thickness, and substantially small heat capacity. The elastic layer 412 is formed from a heat-resistant elastic material such as silicone rubber or fluorocarbon rubber coated on the outer circumferential surface of the core 411. The elastic layer 412 also has a hollow cylinder shape with a relatively small thickness, and contributes to reduction of the heat capacity of the heating roller 41. The release layer 413 is formed from, for example, polytetrafluoroethylene (PTFE) or perfluoroalkoxy alkanes (PFA) thinly coated on the surface of the elastic layer 412. Two halogen lamps 414a and 414b are disposed as examples of heat sources inside the heating roller 41. The two halogen lamps 414a and 414b heat different areas in, for example, the depth direction Y orthogonal to the plane of the drawing. For example, the heating area of the halogen lamp 414a corresponds to an area in a center portion in the axial direction of the heating roller 41 and corresponding to the dimension of the recording sheet 5 of the A4 size in the lateral direction. The heating areas of the halogen lamp 414b correspond to both end portions of the heating roller 41 in the axial direction. The number of the halogen lamps 414a and 414b is not limited to two, and only one halogen lamp may be included.

As illustrated in FIG. 3, both end portions of the heating roller 41 in its longitudinal direction (axial direction) are rotatably supported by the first support frames 431 of the device housing 43 with bearing members 439 interposed therebetween. The heating roller 41 is driven to rotate at a predetermined speed in a direction of arrow C by a driving motor, not illustrated, disposed at the apparatus body 1a with a driving force transmission gear 415 (refer to FIG. 2) engaged with a driving gear not illustrated attached at one end portion in the axial direction. The pressing belt 42 is driven to rotate as a result of being pressed against the heating roller 41 that is driven to rotate, at the fixing process portion N.

The rotation speed, that is, the fixing speed of the heating roller 41 may be set at several levels such as high speed, medium speed, or low speed, in accordance with, for example, the basis weight or the material of the recording sheet 5.

The surface temperature of the heating roller 41 is detected by a temperature sensor not illustrated. The electricity supplied to the halogen lamps 414a and 414b of the heating roller 41 is controlled by a temperature control circuit formed from, for example, a triac not illustrated based on a detection result from the temperature sensor. The surface of the heating roller 41 is thus kept at a predetermined fixing temperature.

As illustrated in FIG. 4, the pressing unit 44 includes the pressing belt 42, a pressing holding member 45, first and second support members 46 and 47, guide members 48, a sliding sheet 49, and first and second felt members 70 and 71. The pressing holding member 45 functions as a pressure contact portion and a holding portion. The pressing holding member 45 includes a first pressure contact portion 451 that is disposed inside the pressing belt 42 and that presses the pressing belt 42 against the surface of the heating roller 41. The pressing holding member 45 also includes a holding portion 452 that is disposed inside the pressing belt 42 and that holds the pressing belt 42 at an upstream end portion in the movement direction of the pressing belt 42. The first and second support members 46 and 47 support the pressing holding member 45 to allow the pressing holding member 45 to be pressed against the surface of the heating roller 41. The guide members 48 guide both end portions of the pressing belt 42 in the longitudinal direction to allow the pressing belt 42 to rotate. The sliding sheet 49 is interposed between the pressing belt 42 and the pressing holding member 45 to reduce sliding resistance. The first and second felt members 70 and 71 are disposed inside the pressing belt 42, and hold a lubricant to be applied to the inner peripheral surface of the pressing belt 42.

The pressing belt 42 is an endless belt formed from a flexible material, and has a thin hollow cylindrical shape in a release state before being attached. The pressing belt 42 includes, for example, a base layer, an elastic layer coated on the surface of the base layer, and a release layer coated on the surface of the elastic layer. Alternatively, the pressing belt 42 may include a base layer and a release layer directly coated on the surface of the base layer. The base layer is formed from a heat-resistant synthetic resin such as a polyimide resin, a polyamide resin, or a polyamide-imide resin, or a metal such as stainless steel, nickel, or copper. The elastic layer is formed from a heat-resistant elastic material such as silicone rubber or fluorocarbon rubber. The release layer is formed from a material such as polytetrafluoroethylene (PTFE) or perfluoroalkoxy alkanes (PFA). The pressing belt 42 may have, for example, a thickness of approximately 50 to 200 μm.

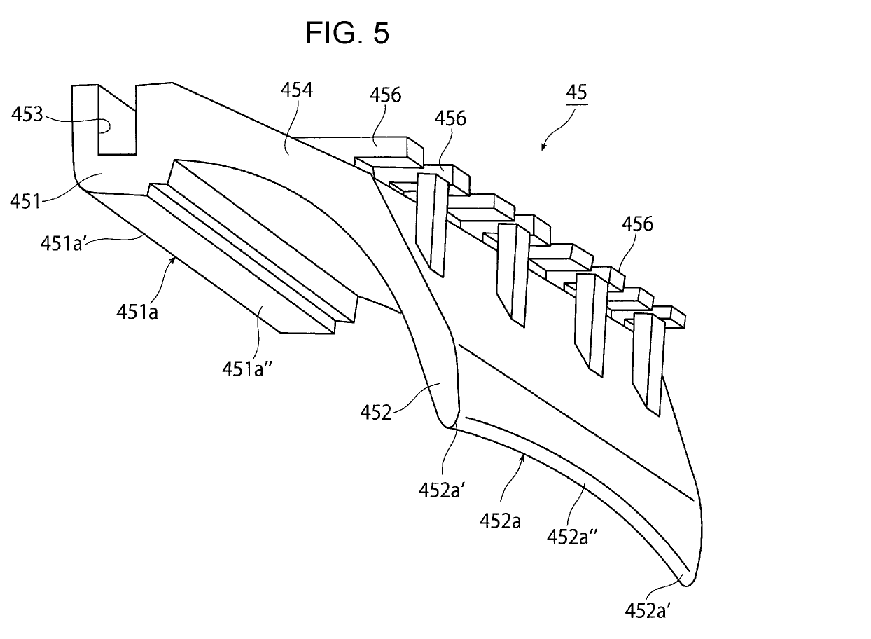

As illustrated in FIG. 5, the pressing holding member 45 is formed from, for example, a heat-resistant synthetic resin formed into an integrated predetermined shape by injection molding. Examples of a heat-resistant synthetic resin include liquid crystal polymer (LCP), polyetheretherketone (PEEK), polyphenylenesulfide (PPS), polyether sulfone (PES), polyamide-imide (PAI), polytetrafluoroethylene (PTFE), polychlorotrifluoro-ethylene (PCTFE), polyvinylidene difluoride (PVDF), and a composite material containing any two or more of these.

As illustrated in FIG. 4, as described above, the pressing holding member 45 includes the first pressure contact portion 451 that is disposed in the fixing process portion N at a downstream end portion in the rotation direction of the pressing belt 42 and that presses the pressing belt 42 against the surface of the heating roller 41. As illustrated in FIG. 5, the first pressure contact portion 451 is disposed substantially throughout in the longitudinal direction (width direction) crossing the movement direction of the pressing belt 42. The first pressure contact portion 451 has a pressed surface 451a that protrudes toward the surface of the heating roller 41 and that is pressed against the heating roller 41 with the pressing belt 42 and the sliding sheet 49 interposed therebetween. The first pressure contact portion 451 has a larger thickness than other portions. The first pressure contact portion 451 has a groove 453 extending in the longitudinal direction. A distal end of the first support member 46 is fitted into the groove 453. The pressed surface 451a of the first pressure contact portion 451 includes a first pressed surface 451a' and a second pressed surface 451a". The first pressed surface 451a' is located at a downstream end portion in the movement direction of the pressing belt and has a curved shape. The second pressed surface 451a" is located upstream from the first pressed surface 451a' in the movement direction of the pressing belt 42 and has a flat shape.

The pressing holding member 45 includes a second pressure contact portion 454 integrated with and upstream from the first pressure contact portion 451 in the movement direction of the pressing belt 42. The second pressure contact portion 454 has an arc shape or a curved shape spaced a predetermined distance apart from the surface of the heating roller 41. As illustrated in FIG. 4, a sheet-shaped elastic member 455 formed from an elastic material such as silicone rubber foam with a predetermined thickness is disposed on the inner surface of the second pressure contact portion 454. The elastic member 455 forms the fixing process portion N together with the first pressure contact portion 451, by pressing the pressing belt 42 against the surface of the heating roller 41.

In the fixing device 40 according to the first exemplary embodiment, as described above, the fixing process portion N is formed by the first pressure contact portion 451 of the pressing holding member 45 and the elastic member 455 disposed at the second pressure contact portion 454. Particularly, the elastic member 455 disposed at the second pressure contact portion 454 is disposed over the surface of the heating roller 41 in an area having a predetermined center angle θ (40 to 60 degrees). In the fixing device 40, the fixing process portion N has a relatively larger area than that in an existing fixing device. Thus, the fixing device 40 according to the first exemplary embodiment provides sufficiently high pressing force and achieves preferable fixing performance regardless of when the pressing force per unit area in the fixing process portion N is reduced.

The pressing holding member 45 integrally includes the holding portion 452 disposed inside the pressing belt 42 at a portion upstream from the second pressure contact portion 454 in the movement direction of the pressing belt 42. The holding portion 452 holds the pressing belt 42 at an upstream end portion of the first pressure contact portion 451 in the movement direction of the pressing belt 42.

As illustrated in FIG. 4, the holding portion 452 of the pressing holding member 45 has an arc shape or a curved shape to be spaced further outward from the surface of the heating roller 41 in a nearly radial direction than the second pressure contact portion 454. A distal end 452a of the holding portion 452 has an arc-shaped cross section to smoothly hold the inner peripheral surface of the pressing belt 42.

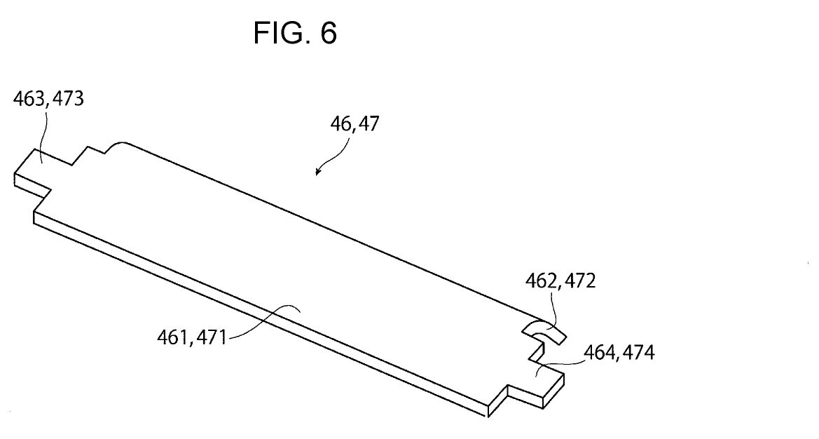

The first and second support members 46 and 47 are each formed from a plate of a metal such as stainless steel, aluminum, or iron. In the illustrated example, the first support member 46 is thicker than the second support member 47. As illustrated in FIG. 4 and FIG. 6, the first support member 46 has an L-shaped cross section, including a vertical plate portion 461 and a horizontal plate portion 462. The vertical plate portion 461 is disposed substantially perpendicular to the surface of the heating roller 41. The horizontal plate portion 462 is bent in a direction crossing the base end portion of the vertical plate portion 461. The vertical plate portion 461 of the first support member 46 is disposed along a first straight line L1 passing through a center O of the heating roller 41 and extending in a radial direction. The second support member 47 has a L-shaped cross section, including a vertical plate portion 471 and a horizontal plate portion 472. The vertical plate portion 471 is parallel to the vertical plate portion 461 of the first support member 46. The horizontal plate portion 472 is bent in a direction crossing the base end portion of the vertical plate portion 471. The horizontal plate portion 462 of the first support member 46 and the horizontal plate portion 472 of the second support member 47 are disposed to face each other with a gap interposed therebetween.

As illustrated in FIG. 3 and FIG. 6, each of the first and second support members 46 and 47 is fixed while having protrusions 463 and 464 or 473 and 474 of the corresponding vertical plate portion 461 or 471 at both end portions in the longitudinal direction fitted to opening portions 432a and 432b of the second support frames 432.

As illustrated in FIG. 3 and FIG. 4, the second support member 47 is disposed to allow the distal end of the vertical plate portion 471 to abut against multiple (eight, in the illustrated drawing) contact portions 456 disposed at the rear surface of the second pressure contact portion 454 of the pressing holding member 45.

More specifically, multiple contact portions 456 are arranged in the longitudinal direction to be integrated on the rear surface of the second pressure contact portion 454 of the pressing holding member 45. As illustrated in FIG. 4, the pressing holding member 45 is positioned and fixed while having the distal end of the vertical plate portion 461 of the first support member 46 fitted into the groove 453 formed in the rear surface of the first pressure contact portion 451.

As described above, the second pressure contact portion 454 of the pressing holding member 45 is pressed against the surface of the heating roller 41 with the elastic member 455 interposed therebetween as a result of the distal end of the vertical plate portion 471 of the second support member 47 coming into contact with the contact portions 456.

As illustrated in FIG. 4, the base end portion of the sliding sheet 49 is locked by lock pins 457 at the distal ends of the contact portions 456 of the pressing holding member 45.

As illustrated in FIG. 3 and FIG. 5, multiple (four, in the illustrated example) guide portions 458 are disposed at the second pressure contact portion 454 of the pressing holding member 45. The multiple guide portions 458 are each located between adjacent two of the contact portions 456 of the pressing holding member 45. The multiple guide portions 458 separate a portion, located near the base end, of the rear surface of the sliding sheet 49 having the base end locked onto the contact portions 456 apart from the second pressure contact portion 454, and guide the rear surface to the holding portion 452 of the pressing holding member 45.

As illustrated in FIG. 4, first and second felt members 70 and 71 are disposed on the outer surfaces of the horizontal plate portions 462 and 472 of the first and second support members 46 and 47 with a method such as adhesion. The first and second felt members 70 and 71 support the pressing belt 42 while being elastically deformed when the pressing belt 42 exerts its tension as a result of being driven to rotate. For convenience, FIG. 4 illustrates the first and second felt members 70 and 71 with a rectangular cross section before being elastically deformed.

The first and second felt members 70 and 71 are impregnated with a predetermined amount of a lubricant to be applied to the inner peripheral surface of the pressing belt 42. For example, amino modified silicone oil with a viscosity of 100 to 350 cs is used as the lubricant. The lubricant is impregnated into the first and second felt members 70 and 71 in advance to be applied to the inner peripheral surface of the pressing belt 42. However, this is not the only possible example. The lubricant may be initially applied to the inner peripheral surface of the pressing belt 42.

The sliding sheet 49 is formed from a thin, long, flat rectangular sheet. As an example of the sliding sheet 49, a construction including a base layer formed from fluororesin such as polytetrafluoroethylene (PTFE) and a textile or knitting formed from, for example, aramid fiber and laminated on a surface or both top and rear surfaces of the base layer is used. As illustrated in FIG. 4, the distal end of the sliding sheet 49 extends to an upper portion of the first pressure contact portion 451 of the pressing holding member 45.

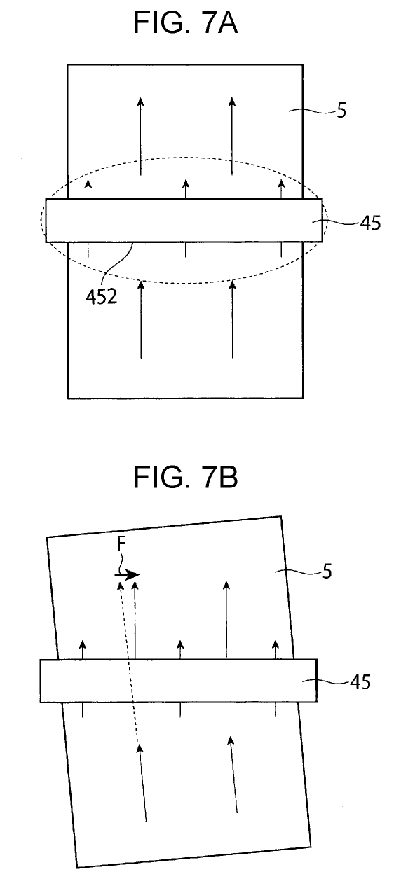

As illustrated in FIG. 7A, in an existing fixing device 40, the distal end of the holding portion 452 of the pressing holding member 45 linearly holds the pressing belt 42 in the width direction crossing the movement direction of the pressing belt 42. This fixing device 40 transports the recording sheet 5 orthogonally to the width direction crossing the movement direction of the pressing belt 42. Thus, the movement direction of the recording sheet 5 matches the movement direction of the pressing belt 42. At this time, the recording sheet 5 is transported at a uniform transport speed in the width direction crossing the movement direction. Thus, the recording sheet 5 undergoes the fixing process without producing creases while passing the fixing process portion N where the heating roller 41 and the pressing belt 42 are in pressure contact with each other.

As illustrated in FIG. 7B, in the existing fixing device 40, the recording sheet 5 may be transported while being inclined with respect to the width direction crossing the movement direction of the pressing belt 42 of the pressing holding member 45. In this fixing device 40, the moving direction of the recording sheet 5 before the recording sheet 5 enters the fixing process portion N differs from the moving direction of the recording sheet 5 in which the recording sheet 5 is transported through the fixing process portion N by the pressing belt 42. Thus, the movement direction of the recording sheet 5 while the recording sheet 5 is passing the pressing holding member 45 is forcibly changed to the direction crossing the former moving direction. Thus, a compressive force F may be exerted on the recording sheet 5 that passes the pressing holding member 45 forming the fixing process portion N, in the direction crossing the movement direction, and creases are produced. Creases are notably produced in the recording sheet 5 when the recording sheet 5 is a thin paper sheet with relatively small stiffness, that is, a relatively small basis weight.

The fixing device according to the exemplary embodiment includes a holding portion disposed inside the belt. The holding portion holds, at a portion upstream from its center portion, both end portions of the belt in the width direction crossing the movement direction of the belt at a portion upstream from the pressure contact portion in the movement direction.

In the fixing device according to the exemplary embodiment, the holding portion is integrated with the pressure contact portion at a portion upstream from the pressure contact portion in the movement direction of the belt.

In the fixing device according to the exemplary embodiment, the holding portion is disposed at an upstream end portion in the movement direction of the belt, and has a recessed shape at a portion that holds the belt.

More specifically, as illustrated in FIG. 4, the fixing device 40 according to the first exemplary embodiment includes the pressing holding member 45 that is disposed inside the pressing belt 42. The pressing holding member 45 holds the elastic member 455 and presses the pressing belt 42 against the heating roller 41, and includes the holding portion 452 that holds the pressing belt 42. The holding portion 452 is integrated with the pressure contact portions 451 and 454 at a portion upstream from the first and second pressure contact portions 451 and 454 in the movement direction of the pressing belt 42.

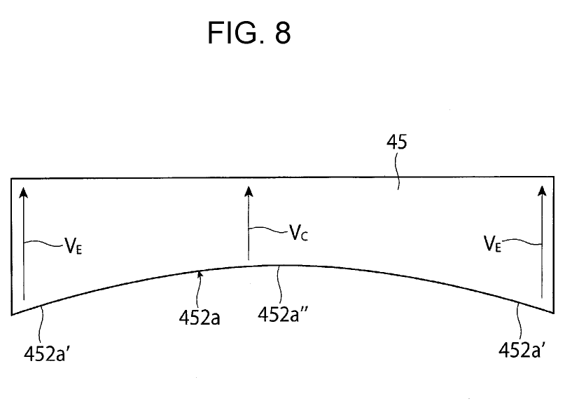

As illustrated in FIG. 5 and FIG. 8, in the holding portion 452 of the pressing holding member 45, at the distal end 452a or an upstream end portion in the movement direction of the pressing belt 42, both end portions 452a' serving as examples of first portions in the width direction crossing the movement direction of the pressing belt 42 have a recessed shape connected with a curve located upstream in the movement direction of the pressing belt 42 from a center portion 452a" serving as an example of a second portion. The upstream distal end 452a of the holding portion 452 has a recessed shape laterally symmetric with respect to the center in the width direction crossing the movement direction of the pressing belt 42. The recessed shape of the holding portion 452 has a predetermined radius of curvature or a curved shape.

As illustrated in FIG. 4, when the pressing belt 42 moves while being pressed against the outer peripheral surface of the heating roller 41 at the fixing process portion N, a predetermined tension is exerted on the pressing belt 42. The upstream end portion of the pressing belt 42 in the movement direction is held by the holding portion 452 of the pressing holding member 45. Thus, as illustrated in FIG. 8, while the pressing belt 42 is moving at the fixing process portion N, the upstream end portion of the pressing belt 42 in the movement direction follows the recessed shape of the distal end 452a of the holding portion 452 of the pressing holding member 45.

After the pressing belt 42 passes the holding portion 452 of the pressing holding member 45, the pressing belt 42 moves at the fixing process portion N while being pressed against the surface of the heating roller 41 by the second pressure contact portion 454 and the first pressure contact portion 451 of the pressing holding member 45.

As illustrated in FIG. 8, at this time, the distal end 452a of the holding portion 452 of the pressing holding member 45 has a recessed shape. Thus, in the pressing belt 42, both end portions in the longitudinal direction are to move by a longer distance than the center portion to pass the fixing process portion N because the holding portion 452 of the pressing holding member 45 has a recessed shape. Thus, in the pressing belt 42, both end portions in the longitudinal direction move at a higher speed than the center portion.

### Operation of Fixing Device

As described below, the fixing device according to the first exemplary embodiment with the above structure is a fixing device that presses an endless belt against a rotational body using a pressure contact portion disposed inside, and that includes a holding portion that holds the belt at a portion upstream from the pressure contact portion in the movement direction of the belt. The fixing device is capable of further reducing creases produced in a recording medium than in a structure in which the holding portion linearly holds the belt in the width direction crossing the movement direction of the belt.

More specifically, as illustrated in FIG. 4, in the fixing device 40 according to the first exemplary embodiment, halogen lamps 414a and 414b disposed inside the heating roller 41 receive electricity to start a fixing operation, and are heated to heat the surface of the heating roller 41 to a predetermined fixing temperature.

In the fixing device 40, when the heating roller 41 is driven to rotate, the pressing belt 42 pressed against the surface of the heating roller 41 at the fixing process portion N is also driven to rotate with the rotation of the heating roller 41. The pressing belt 42 is pressed against the surface of the heating roller 41 by the first and second pressure contact portions 451 and 454 of the pressing holding member 45, and held by the holding portion 452 of the pressing holding member 45.

At this time, the distal end 452a of the holding portion 452 of the pressing holding member 45 has a recessed shape to allow both end portions 452a' in the width direction crossing the movement direction of the pressing belt 42 to be located upstream from the center portion 452a" in the movement direction of the pressing belt 42. In the pressing belt 42, both end portions move at a higher speed than the center portion in the width direction crossing the movement direction while the pressing belt 42 is pressed against the surface of the heating roller 41 and moving from the distal end 452a of the holding portion 452 of the pressing holding member 45 to the second and first pressure contact portions 454 and 451.

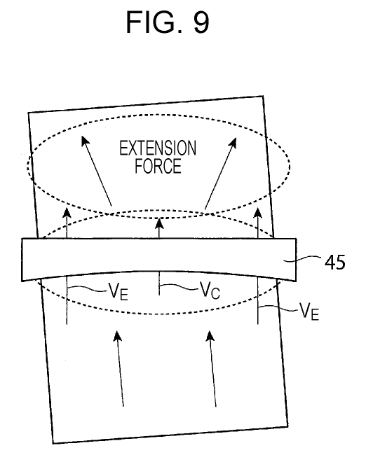

As illustrated in FIG. 9, a case is assumed where the recording sheet 5 enters the pressing holding member 45 in the fixing device 40 according to the first exemplary embodiment while being inclined with respect to the pressing holding member 45. The recording sheet 5 is held between and transported by the heating roller 41 and the pressing belt 42 at the fixing process portion N formed by the pressing holding member 45. At this time, both end portions of the pressing belt 42 move at a movement speed V_{E} higher than a movement speed V_{c} of the center portion in the width direction crossing the movement direction. When the recording sheet 5 passes through the fixing process portion N formed by the pressing holding member 45, the recording sheet 5 is transported while receiving an extension force of extending from the center portion to the both end portions in the width direction.

Thus, the fixing device 40 according to the first exemplary embodiment produces no or fewer creases in the recording sheet 5 regardless of when the recording sheet 5 enters the fixing process portion N while being inclined with respect to the fixing process portion N.

In the fixing device 40 according to the first exemplary embodiment, the holding portion 452 of the pressing holding member 45 that holds the pressing belt 42 has a curved shape. This structure does not affect the shape of the fixing process portion N unlike when the outer diameter of the heating roller 41 at both end portions in the axial direction is increased further than at the center portion, or the pressure contact portion pressed against the heating roller 41 at the center portion of in the axial direction protrudes further than at both end portions. This structure thus reduces adverse effects on an image on the recording sheet 5, such as deterioration of the fixing performance of the heating roller 41 at the center portion in the axial direction compared to the both end portions.

The fixing device 40 according to the first exemplary embodiment is formed by simply changing the shape of the holding portion 452 of the pressing holding member 45. Thus, compared to a structure where the outer diameter of the heating roller 41 is changed by, for example, setting the thickness of the elastic layer 412 as appropriate, the fixing device 40 does not increase production costs for, for example, the heating roller 41.

### Experimental Example

The inventors of the present disclosure conduct experiments to confirm the effects of the fixing device 40 according to the first exemplary embodiment. As illustrated in FIG. 4 and FIG. 5, a device in which the distal end 452a of the holding portion 452 in the pressing holding member 45 has a curved shape is prototyped and used as the fixing device 40. Tracing paper sheets of an A4 size with basis weights of 49 g/m², 54 g/m², and 60 g/m² are used as the recording sheets 5. Experiments are conducted on the recording sheets 5 to check whether creases are produced in the recording sheets 5 when the recording sheets 5 are transported while being inclined obliquely with respect to a regular transport direction as illustrated in FIG. 9. An ordinary paper sheet usually has basis weights of 64 to 68 g/m². Thus, the tracing paper sheets with basis weights of 49 g/m², 54 g/m², and 60 g/m² correspond to so-called thin paper sheets that are more likely to have creases. As illustrated in FIGS. 7A and 7B, as a comparative example, an existing fixing device 40 including the holding portion 452 of the pressing holding member 45 having a straight line shape extending in the width direction crossing the transport direction of the recording sheet is used to check whether creases are produced.

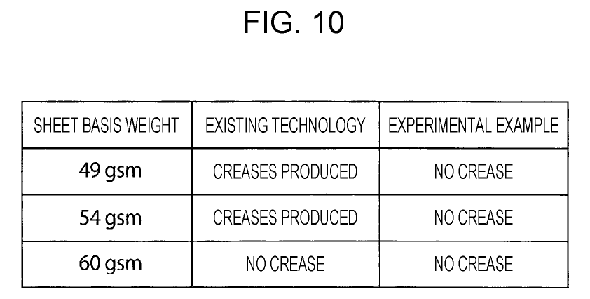

FIG. 10 is a table illustrating results of the experimental example and the comparative example.

As is clear from FIG. 10, the fixing device 40 according to the first exemplary embodiment produces no creases regardless of when tracing paper sheets with basis weights of 49 g/m², 54 g/m², and 60 g/m² are used.

The fixing device 40 according to the comparative example produces no creases in a tracing paper sheet with a basis weight of 60 g/m², which is relatively high. However, the fixing device 40 produces creases in tracing paper sheets with basis weights of 49 g/m² and 54 g/m².

As described above, the fixing device 40 according to the first exemplary embodiment produces no creases in tracing paper sheets with basis weights of 49 g/m², 54 g/m², and 60 g/m².

In the exemplary embodiment described above, the present disclosure is applied to a full-color image forming apparatus, but is similarly applicable to a monochrome image forming apparatus.

In the exemplary embodiment described above, the holding portion of the pressing holding member is formed by connecting, with a curve, the first portions that are in contact with both end portions of the belt in the width direction and the second portion that is in contact with the center portion of the belt in the width direction. However, the present disclosure is not limited to this, and the holding portion may be formed by connecting the first portions and the second portion with one or more straight lines, or may be formed by connecting the first portions and the second portion with a combination of a straight line and a curve.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

Appendix (((1))) A fixing device, comprising:

a rotational body heated by a heat source;

an endless belt that rotates while being pressed against the rotational body with a pressure contact portion; and

a holding portion that is disposed inside the belt at a portion upstream from the pressure contact portion in a movement direction of the belt, and that holds two end portions of the belt in a width direction crossing the movement direction of the belt, at portions upstream from a center portion of the belt.

(((2))) The fixing device according to (((1))),

wherein the holding portion is integrated with the pressure contact portion at a portion upstream from the pressure contact portion in the movement direction of the belt.

(((3))) The fixing device according to (((2))),

wherein the holding portion is disposed at an upstream end portion in the movement direction of the belt, and has a recessed shape at a portion that holds the belt.

(((4))) The fixing device according to (((1))),

wherein the holding portion includes first portions that come into contact with the two end portions of the belt in the width direction and a second portion that comes into contact with the center portion of the belt in the width direction, and the first portions are located upstream from the second portion in the movement direction of the belt.

(((5))) The fixing device according to (((4))),

wherein the holding portion is formed by connecting the first portions and the second portion with a curve.

(((6))) The fixing device according to (((1))),

wherein the pressure contact portion includes a first pressure contact portion and a second pressure contact portion, the first pressure contact portion is disposed at a downstream end portion in the movement direction of the belt to directly press the belt against the rotational body, and the second pressure contact portion is disposed upstream from the first pressure contact portion in the movement direction of the belt to press the belt against the rotational body with an elastic member interposed therebetween.

(((7))) The fixing device according to (((6)))

wherein the holding portion is disposed upstream from the second pressure contact portion in the movement direction of the belt.

(((8))) The fixing device according to (((7))),

wherein the holding portion is spaced outward in a radial direction from an outer peripheral surface of the rotational body.

(((9))) An image forming apparatus, comprising:

an image forming unit that forms an image on a recording medium; and

a fixing unit that fixes the image on the recording medium,

wherein the fixing device according to any one of (((1))) to (((8))) is used as the fixing unit.

What is claimed is:

1. A fixing device, comprising:
a rotational body heated by a heat source;
an endless belt that rotates while being pressed against the rotational body with a pressure contact portion; and
a holding portion that is disposed inside the belt at a portion upstream from the pressure contact portion in a movement direction of the belt, and that holds two end portions of the belt in a width direction crossing the movement direction of the belt, at portions upstream from a center portion of the belt.

2. The fixing device according to claim 1,
wherein the holding portion is integrated with the pressure contact portion at a portion upstream from the pressure contact portion in the movement direction of the belt.

3. The fixing device according to claim 2,
wherein the holding portion is disposed at an upstream end portion in the movement direction of the belt, and has a recessed shape at a portion that holds the belt.

4. The fixing device according to claim 1,
wherein the holding portion includes first portions that come into contact with the two end portions of the belt in the width direction and a second portion that comes into contact with the center portion of the belt in the width direction, and the first portions are located upstream from the second portion in the movement direction of the belt.

5. The fixing device according to claim 4,
wherein the holding portion is formed by connecting the first portions and the second portion with a curve.

6. The fixing device according to claim 1,
wherein the pressure contact portion includes a first pressure contact portion and a second pressure contact portion, the first pressure contact portion is disposed at a downstream end portion in the movement direction of the belt to directly press the belt against the rotational body, and the second pressure contact portion is disposed upstream from the first pressure contact portion in the movement direction of the belt to press the belt against the rotational body with an elastic member interposed therebetween.

7. The fixing device according to claim 6,
wherein the holding portion is disposed upstream from the second pressure contact portion in the movement direction of the belt.

8. The fixing device according to claim 7,
wherein the holding portion is spaced outward in a radial direction from an outer peripheral surface of the rotational body.

9. An image forming apparatus, comprising:
an image forming unit that forms an image on a recording medium; and
a fixing unit that fixes the image on the recording medium,
wherein the fixing device according to claim 1 is used as the fixing unit.

10. An image forming apparatus, comprising:
an image forming unit that forms an image on a recording medium; and
a fixing unit that fixes the image on the recording medium,
wherein the fixing device according to claim 2 is used as the fixing unit.

11. An image forming apparatus, comprising:
an image forming unit that forms an image on a recording medium; and
a fixing unit that fixes the image on the recording medium,
wherein the fixing device according to claim 3 is used as the fixing unit.

12. An image forming apparatus, comprising:
an image forming unit that forms an image on a recording medium; and
a fixing unit that fixes the image on the recording medium,
wherein the fixing device according to claim 4 is used as the fixing unit.

13. An image forming apparatus, comprising:
an image forming unit that forms an image on a recording medium; and
a fixing unit that fixes the image on the recording medium,
wherein the fixing device according to claim 5 is used as the fixing unit.

14. An image forming apparatus, comprising:
an image forming unit that forms an image on a recording medium; and
a fixing unit that fixes the image on the recording medium,
wherein the fixing device according to claim 6 is used as the fixing unit.

15. An image forming apparatus, comprising:
an image forming unit that forms an image on a recording medium; and
a fixing unit that fixes the image on the recording medium,
wherein the fixing device according to claim 7 is used as the fixing unit.

16. An image forming apparatus, comprising:
an image forming unit that forms an image on a recording medium; and
a fixing unit that fixes the image on the recording medium,
wherein the fixing device according to claim 8 is used as the fixing unit.

17. A fixing device, comprising:
rotational means heated by a heat source;
endless belt means for rotating while being pressed against the rotational means with a pressure contact portion; and
a holding means, disposed inside the belt means at a portion upstream from the pressure contact portion in a movement direction of the belt means, for holding two end portions of the belt means in a width direction crossing the movement direction of the belt means, at portions upstream from a center portion of the belt means.
